(19) United States
(12) Patent Application Publication
(10) Pub. No.: US 2010/0014708 A1
(43) Pub. Date: Jan. 21, 2010

(54) TARGET RANGE-FINDING METHOD AND DEVICE

(76) Inventor: Cheng-Kuang HSU, Toufen Town (TW)

Correspondence Address: EGBERT LAW OFFICES, 412 MAIN STREET, 7TH FLOOR, HOUSTON, TX, 77002, US

(21) Appl. No.: 12/176,903

(22) Filed: Jul. 21, 2008

(51) Int. Cl. G06K 9/46

(52) U.S. Cl. 382/103

(57) ABSTRACT

The present invention provides a target range-finding method and device. The device includes a marking portion on the target, which is set with an area or size and defined by a first and second measurement edge. An image acquisition device includes a lens and operating screen. The operating screen displays the target image captured by the image acquisition device. A measuring mark selection unit selects the position of the first and second measurement edges of the target image from the operating screen of the image acquisition device. A processing unit calculates the range of the target. The target range-finding device presents better range-finding accuracy, ease-of-operation and higher efficiency as well as improved applicability.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a target range-finding method and device, and more particularly to an innovative method and device which arranges or assigns a marking portion on the target, then captures and processes the images through an image acquisition device and processing unit for the purpose of range-finding.

2. Description of Related Art Including Information Disclosed Under 37 CFR 1.97 and 37 CFR 1.98

The range of a target is often required to be accurate in everyday life; for example, a golf player could improve golf shots in a controlled way if the range of targeted holes is learnt accurately. The problem of determining the range of a target is generally resolved by means of individual visualization, inference and judgment, or by asking for experienced caddies. However, large errors may still occur due to lack of experience or absence of experienced professionals.

At present, positioning is made possible through mobile phones or personal digital assistants (PDAs) based on global positioning satellite (GPS) navigation devices and electronic mapping technology. Range-finding for the target is achieved by comparing with the electronic maps. However, this method is limited since GPS for the mobile phones or PDAs have not reached the positioning accuracy to the nearest centimeter of digital global positioning satellites (DGPS). For this reason, the range-finding process is time-consuming and inconvenient due to errors.

In addition, laser technology is used for determining the range of targets, but the laser points are difficult to be located and identified visually.

Moreover, a method to find the range of a target based on a digital camera is developed by following traditional ranging telescope structures. A reference line must be set first, and then a reference dimension (e.g. 150, 160, 170 cm) for the objects (e.g. persons, trees and vehicles) is set for measurement purposes. Yet, if there is a dimensional deviation, the physical range calculated by the operational procedure will generate relative error, leading to poor accuracy in finding the range of the target.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

The present invention is technically characterized by having a marking portion of predefined size being arranged on the target. The principle of the operation is based on the program of the processing unit using a predefined image parameter of the marking portion on the operating screen of the image acquisition device, thereby obtaining a highly accurate range-finding result. During the process of find the range of the target, the operator is only required to press down the short-cut key to capture the target image, and select, efficiently and conveniently, the first and second measurement edges of the marking portion from the operating screen of image acquisition device via the measuring mark selection unit. Thus, the target range-finding device and method of the present invention overcomes the shortcomings of the typical target range-finding product, better presenting range-finding accuracy, ease-of-operation and higher efficiency as well as improved applicability.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 depicts a perspective view of the preferred embodiment of target range-finding device of the present invention.

FIG. 2 depicts a side elevation view of the image acquisition device of the present invention.

FIG. 3 depicts a schematic view of the application of the marking portion model of the present invention.

FIG. 4 depicts another schematic view of the application of the marking portion model of the present invention.

FIG. 5 depicts a schematic illustration, including a text block chart for the target range-finding device of the present invention.

FIG. 6 depicts another schematic illustration, including the text block chart for the target range-finding method of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

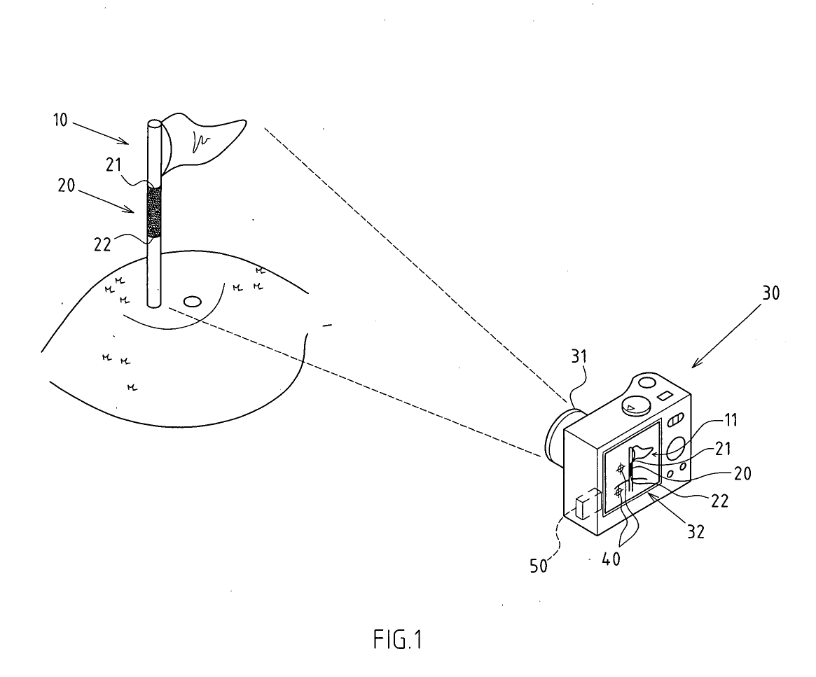

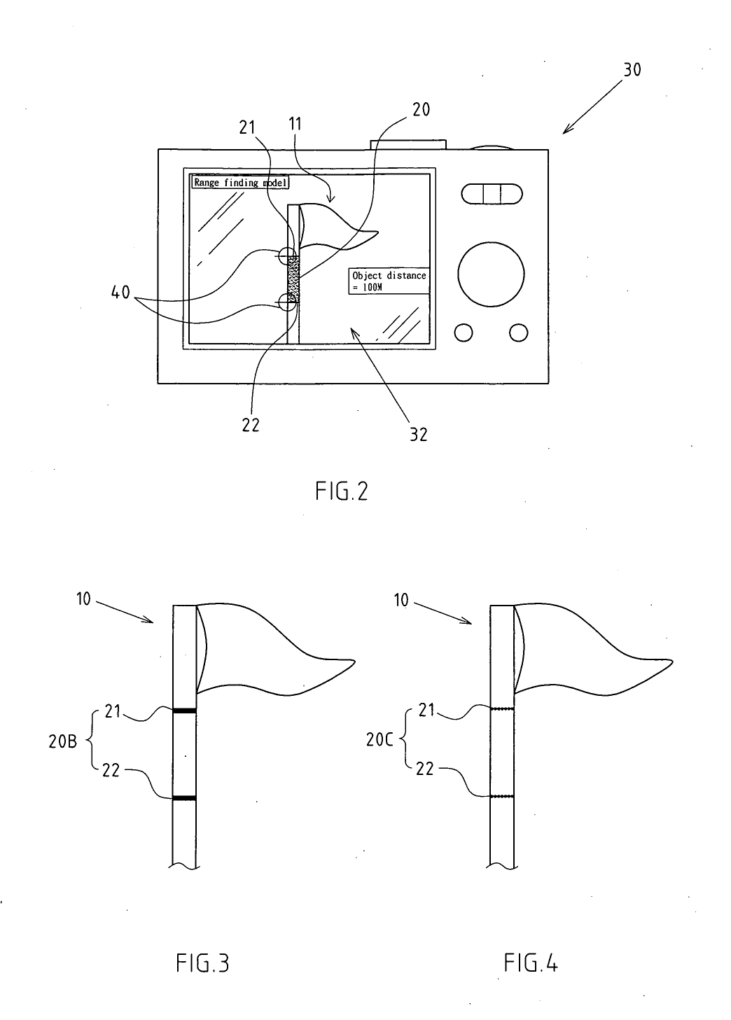

FIGS. 1-2 depict preferred embodiments of a target range-finding method and device of the present invention. The embodiments are only provided for explanatory purposes with respect to the patent claims.

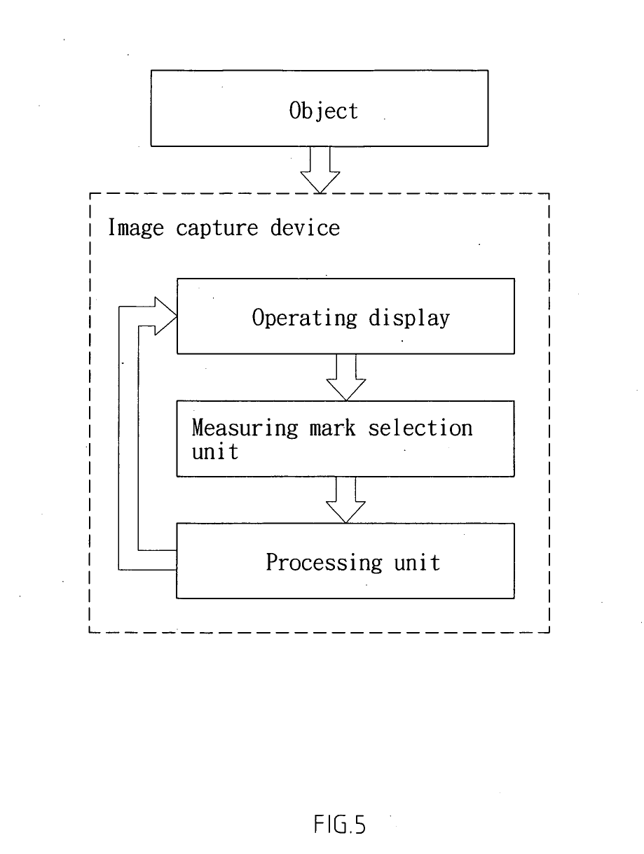

The target range-finding device includes a marking portion 20 located on the target 10, illustrated as a flag pole in a golf course FIG. 1. The marking portion 20 with a preset area or size is defined into a first measurement edge 21 and a second measurement edge 22 with a spacing. The marking portion 20 is presented by color blocks as illustrated in FIGS. 1 and 2. The marking portion 20B is also presented by gage marks or luminous gage marks, as illustrated in FIG. 3. The marking portion 20C is presented by luminous bodies as illustrated in FIG. 4.

An image acquisition device 30 comprises a lens 31 and an operating screen 32. The operating screen 32 can display the clear image (hereinafter referred to as target image 11) of the target 10 captured via the lens 31 by image acquisition device 30. The image acquisition device currently refers to a digital camera, PDA, mobile phone and digital telescope.

A measuring mark selection unit 40 is used to select the position of first and second measurement edges 21, 22 of the target image 11 from the operating screen 32 of the image acquisition device 30. The measuring mark selection unit 40 is presented axially or grippingly, or set manually for automatic image acquisition by selection of range-finding marks.

A processing unit 50 is used to calculate the range of a target 10 (i.e. the spacing of the target 10 and position of image acquisition device 30) based on the actual size of the first and second measurement edges 21, 22 of the marking portion 20, as well as the dimension and a preset parameter of the target image 11 displayed on the operating screen 32 of the image acquisition device 30. The range-finding value can be displayed directly in the proper position of the operating screen 32 for easy visualization (as shown in FIG. 2).

The image acquisition device 30 is available with optical or digital or smart zooming/amplification functions.

The processing unit 50 is a built-in unit connecting the image acquisition device.

Alternatively, the processing unit 50 is also an external or plug-in unit connecting the image acquisition device 30.

The marking portion 20 can be arranged onto the target 10 (shown in FIGS. 1 and 2), or set into an article (e.g. vehicle license plate) with nominal dimension, so that the processing unit 50 enables accurate operation by setting the nominal dimension as a fixed parameter.

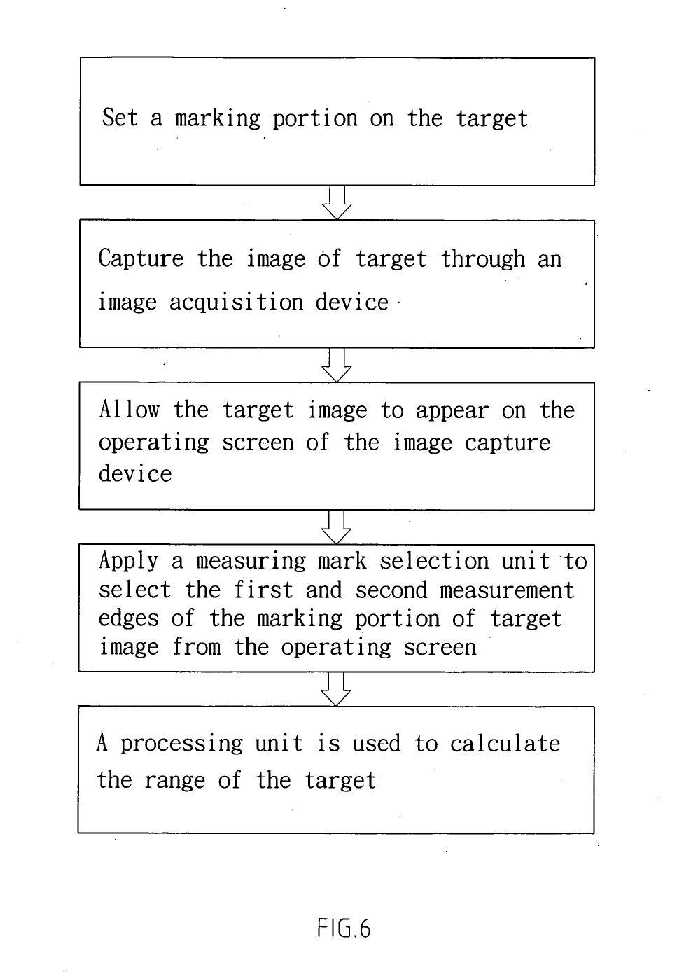

The target range-finding method of the present invention is described below (shown in FIG. 6).

A marking portion 20 is set on the target 10, shown as a flag pole in the preferred embodiment of FIG. 1. The first and second measurement edges 21, 22 are defubed through the set area or dimension of the marking portion 20.

The image of the target 10 is captured through an image acquisition device 30, allowing the target image 11 to be displayed on the operating screen 32 (e.g. LCD panel) of the image acquisition device 30.

A measuring mark selection unit 40 is applied to select the first and second measurement edges 21, 22 of the marking portion 20 of target image 11 from the operating screen 32 of the image acquisition device 30. The purpose of this step is to define the coordinate of the first and second measurement edges 21, 22 of the marking portion 20 from the operating screen 32 of the image acquisition device 30, so as to obtain the specific spacing data of the first and second measurement edges 21, 22.

A processing unit 50 is used to calculate the range of the target 10 based on the actual size of the first and second measurement edges 21, 22 of the marking portion 20, as well as the dimension and a preset parameter of the marking portion 20 of the target image 11 displayed on the operating screen 32 of the image acquisition device 30. More specifically, the principle of the processing unit 50 is based on predefined size of the marking portion 20, and the image display mode of the operating screen 32 can also be set. So, the program of the processing unit 50 works in such a manner that a range parameter could be established according to the image size of the marking portion 20 on the operating screen 32. For example, if the actual size of the marking portion 20 is 50 cm, the height of non-zoomed image on the operating screen 32 is 10 mm, and the range measured in advance is 100 m, then, the operation is based on the predefined parameters: 50 cm, 10 mm and 100 m. The processing unit 50 works in such a manner that it enables logical operation according to the dimensional change of the marking portion 20 on the operating screen 32 and the multiplying factor of the lens (including: optical or digital or smart zooming/amplification), thereby obtaining a highly accurate measurement result. For instance: if 5× optical zooming is multiplied by 4× digital zooming, 5×4=20×; if 4× optical zooming is multiplied by 4× digital zooming and 10× amplification, 4×4×10=160×; or an 81× smart zooming ratio is individually used. Certainly, the zooming of different multiplying factors is set with different operational parameters, while optical or digital or smart zooming/amplification functions can be utilized individually or collectively.

As a marking portion must be first arranged on the target, and the flag pole can be generally set as the target for marking portion 20, the present invention is perfectly suited for resolving the range-finding problem of golf holes. In addition, the vehicle license plate has a nominal size, so the target range-finding device and method of the present invention can be used for range-finding purposes along with other supporting devices.

I claim:

1. A target range-finding device, comprising:
a marking portion being located on a target and having a preset size defined by a first and second measurement edge;
an image acquisition device, comprising a lens and an operating screen and displaying a clear image of said target captured by said image acquisition device;
a measuring mark selection unit, selecting a position of said first and second measurement edges of said marking portion of a target image from said operating screen of said image acquisition device; and
a processing unit, calculating a range of the target based on said size of said first and second measurement edges of said marking portion, dimension of said target image, and a preset parameter of said target image displayed on said operating screen of said image acquisition device.

2. The device defined in claim 1, wherein said marking portion has modes, a mode being selected from a group consisting of: color blocks, gage marks, and luminous bodies.

3. The device defined in claim 1, wherein the image acquisition device is comprised of a component, said component being selected from a group consisting of: a digital camera, PDA, mobile phone and digital telescope.

4. The device defined in claim 1, wherein the image acquisition device has optical or digital or smart zooming/amplification functions.

5. The device defined in claim 1, wherein said processing unit is a built-in unit connecting the image acquisition device.

6. The device defined in claim 1, wherein said processing unit is an external or plug-in unit connecting the image acquisition device.

7. The device defined in claim 1, wherein said measuring mark selection unit is presented axially or grippingly, or set manually for automatic image acquisition by selection of range-finding marks.

8. The device defined in claim 1, wherein the marking portion is arranged on the target.

9. The device defined in claim 1, wherein the marking portion has a nominal dimension, whereby the processing unit is set into a fixed parameter.

10. A target range-finding method, comprising the steps of:
arranging a marking portion on a target, said marking portion having a preset size defined by a first measurement edge and a second measurement edge;
capturing a target image by an image acquisition device, said image acquisition device having an operating screen displaying said target image;
selecting a position of the first and second measurement edges in said target image by a measuring mark selection unit from said operating screen of said image acquisition device; and
calculating the range of said target based on the first and second measurement edges of said marking portion and said target image with a dimension and preset parameter with a processing unit.

11. The method defined in claim 10, wherein said marking portion has modes, a mode being selected from a group consisting of: color blocks, gage marks, and luminous bodies.

12. The method defined in claim 10, wherein the image acquisition device is comprised of a component, said component being selected from a group consisting of: a digital camera, PDA, mobile phone and digital telescope.

13. The method defined in claim 10, wherein the image acquisition device has optical or digital or smart zooming/amplification functions.

14. The method defined in claim 10, wherein said processing unit is a built-in unit connecting the image acquisition device.

15. The method defined in claim 10, wherein said processing unit is an external or plug-in unit connecting the image acquisition device.

16. The method defined in claim 10, wherein said measuring mark selection unit is presented axially or grippingly, or set manually for automatic image acquisition by selection of range-finding marks.

17. The method defined in claim 10, wherein the marking portion is arranged on the target.

18. The method defined in claim 10, wherein the marking portion has a nominal dimension, whereby the processing unit is set into a fixed parameter.

19. The method defined in claim 10, wherein said marking portion is a flag pole for marking a hole in a golf course.
